(19) United States
(12) Patent Application Publication
(10) Pub. No.: US 2007/0060131 A1
(43) Pub. Date: Mar. 15, 2007

(54) Telecommunications services apparatus and methods

(76) Inventor: Jeffrey Wilson, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/551,706

(22) PCT Filed: Mar. 25, 2004
(86) PCT No.: PCT/GB04/01299

§ 371 Date: Jul. 24, 2006

(30) Foreign Application Priority Data
Apr. 3, 2003 (GB) 0307719.5

(51) Int. Cl. H04Q 7/20

(52) U.S. Cl. 455/445

(57) ABSTRACT

The apparatus stores for a first user a number of addresses representing members of one of a number of groups of users, the addresses being configurable by the first user. The first user may send a text message to a service address corresponding to that group of users such that the apparatus replicates the text message to members of that group. Also, the first user may make a voice call to the same service address, the apparatus then initiating an audio conference with members of that group.

This invention relates to telecommunications services apparatus, and in particular but not exclusively to such apparatus capable of supporting text and voice communications between multiple users, including for example the Global System for Mobile Communications (GSM) and its associated short message services (SMS).

In order for a new service to be successful in the mobile communications marketplace, the service should ideally meet a number of criteria. The more of these conditions that are satisfied, the more likely the service is to be a success. The criteria are
The service must fulfill a need
The service must be accessible to a high proportion of the user base, ideally to all users
The service concept must be easily understood by most users
Activation of the service must be extremely simple
Use of the service must not require a significant change in behaviour on the part of the user
The service must be technically and economically feasible

If a service can satisfy all of these constraints simultaneously, then a properly engineered and marketed implementation will have a high probability of success.

The requirements of simplicity and not changing user behavior are often neglected, and as a result there are many features available on mobile telephone networks that operators believe that they support, but in practice hardly anybody uses. These human factors are critical to removing the barriers to adoption by the average user.

At present if one wants to send the same SMS message to multiple recipients, it is generally necessary to manually send the message multiple times. Although it is not necessary to re-enter the text of the message, it is generally necessary to perform each send as a separate operation.

Certain sophisticated telephone handsets have the capability of storing within the handset a definition of one or more groups of recipients, usually identified by a label. Some handsets also allow a recipient list to be created at the time of sending. For example, after a message has been created a recipient is normally selected from the handset's internal telephone book. Some handsets then allow additional recipients to be added to the addressee list at this point. When the message is sent the handset then performs a sequence of sending operations one to each nominated recipient. In the case of handsets which support group definition, the same effect is achieved by selecting the ‘group’ name as the single recipient of the message. The handset still performs a sequence of individual sends.

It is also known that some GSM mobile networks support the sending of SMS messages to multiple recipients using functionality built into their short message service centres (SMSCs). This functionality is not widely used or promoted largely because of the complexity and inconvenience of setting it up prior to sending an SMS message.

It is further known that some mobile telephone systems support audio conferencing functions for connection to both analogue and digital telephone communication networks. These systems use either analogue bridges or digital signal processing techniques to combine audio from callers and to play combined audio to each participant in the conference. For instance, the GSM system specifies a digital means for conferencing up to six people. However, the usage model is not intuitive, and some networks have introduced alternative conferencing systems that provide a different usage model.

Today there exist several distinct categories of conferencing
Meet-me services, generally aimed at the residential user. These are normally automatic systems not requiring any booking or operator intervention to set up a conference. Callers dial in at a pre-agreed time and each caller pays for his own call.
Outdial (or Chairman) services, generally aimed at business use. The organiser, or chairman, specifies the telephone numbers to be outdialled by the system, and normally pays for all of the calls. Automated systems exist to allow on-demand chairman-outdial conferencing without operator intervention.
Bureau-based conferencing, where an operator takes bookings and sets up conferences on behalf of a chairman.

Systems for implementing these schemes may either be network based or use ‘in-house’ equipment operated by a company.

Meet-me based schemes suffer from the disadvantage that the audio conference needs to be pre-arranged, with the participants dialling in at an agreed time. For a business meeting, this may be inappropriate since the information to be disseminated in the conference could in many cases be conveyed during the calls necessarily made to agree a start time. For business and other ad-hoc usage of conferencing an outdial model is more appropriate. In most cases this means that the initiator pays for all call legs, but this is not necessarily so. It is possible to implement outdial conferencing with a reverse charge model. In any case, the outdial conference model is the only one that is appropriate for immediate on-demand conferencing.

Traditional outdial conferencing requires that for each invocation of the conference, the chairman must sequentially enter all of the telephone numbers for the other parties. If a call drops during the conference, which is common for mobile telephones, then the chairman must redial the lost party. This number entry scheme is inconvenient for the initiator, and categorises the service as another one of those that is too much trouble to use regularly.

The present invention addresses the problems that make chairman outdial conferencing awkward to use, and in a preferred embodiment advantageously combines the features of a group texting service and a group conferencing service. Using the technique, a mobile subscriber can use one number, which may be a short-code or a phone book entry, as a destination address for a text message or a voice call. As a destination address for a text message, this results in the same text message being sent to all participants of a respective group. As a destination address for a voice call, this results in an instant outdialled conference to all the participants of the same respective group. The participants of the respective group are predefined by the user.

According to one aspect of the invention there is provided telecommunications services apparatus for use with a mobile telephone network, the apparatus being operable to store for a first user addresses representing members of at least one group of users, said addresses being configurable by the first user, wherein the first user may send a text message to a service address corresponding to one of the at least one group of users, the apparatus being thereby operable to replicate the text message to the members of that group of users.

According to another aspect of the invention there is provided a telecommunications services method for a mobile telephone network, the method involving storing for a first user addresses representing members of at least one group of users, said addresses being configurable by the first user, (i) wherein the first user may send a text message to a service address corresponding to one of the at least one group of users, the text message being thereby replicated to the members of that group of users, and/or (ii) wherein the first user may make a voice call to a service address corresponding to one of the at least one group of users, an audio conference thereby being initiated with the members of that group of users.

Further aspects of the invention provide a computer program for carrying out the above method, and a storage medium on which such computer program is stored.

In a preferred embodiment of the invention, a user is very easily able to send a text message to a group of users, or to initiate a voice conference with the group of users. These are known functions in current networks, but in present implementations the usage model is too complex and consequently a barrier to adoption exists that prevents most users from using the service.

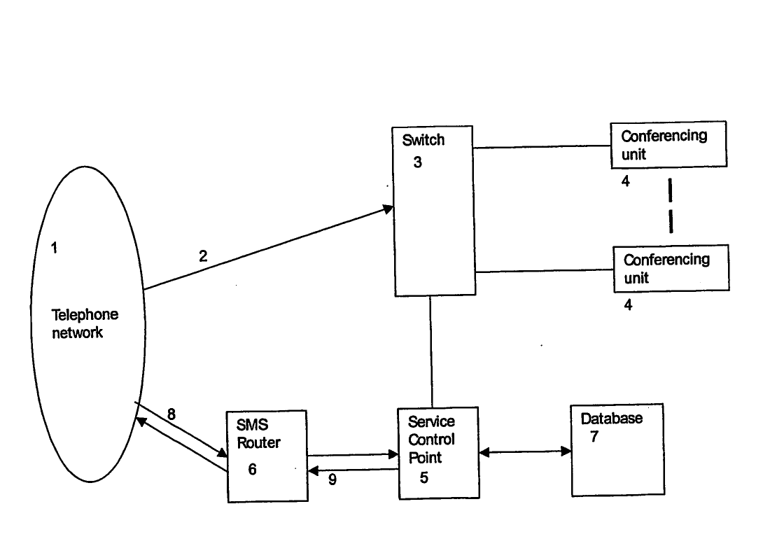

The invention will now be described by way of example with reference to the accompanying drawing FIG. 1) which shows a block diagram of telecommunications services apparatus according to an embodiment of the invention.

Referring to FIG. 1, a telephone network 1 connects voice calls and transmits text messages between attached users. Voice calls 2 addressed to the apparatus for the purpose of initiating a conference call are routed to a switch 3, causing a notification message to be sent to a service control point (SCP) 5 with attached database 7 containing subscriber records including the addresses of a desired group of participants. Under control of the SCP 5, the switch 3 makes outdialled calls to group participants, and connects all parties to a conference bridge on a conferencing unit 4. Mobile originated (MO) text messages 8 addressed to the apparatus are intercepted by an SMS router 6, causing a notification message to be sent to the SCP 5 with attached database 7. Under control of the SCP 5, the SMS router 6 replicates the text message to group participants.

The SMS router 6 may, for example, be a Telsis (RTM) SMS Router, manufactured by Telsis Limited. This equipment is capable of connection to mobile telephone networks using known and standardised signalling protocols such as SS7 and TCP/IP.

In order to achieve simple group configuration, it is desirable that the data storage which defines the members of each group is managed by the network rather than by the users' handsets. It therefore follows that the user must have a means of interacting with the network in order to define and manage the membership of his groups. This mechanism will normally include a means for adding, deleting and listing the members of a group. Many syntaxes are possible for implementation of these mechanisms.

In an embodiment of the invention, the same service number may be used for voice calls that initiate a conference, for text messages that are replicated to an associated group, and for text messages conforming to a specific syntax for defining the members of an associated group. For example, one or more short codes such as 501 to 509 may be allocated by the network for this service. In this case each subscriber that is permitted to use the service may have up to 9 separate groups. Calling 501 will initiate a conference with participants predefined as group, while sending a text message to 507 will replicate the text message to the members predefined as group 7, etc. Each group is said to be associated with the respective service numbers 501 to 509.

The identities of the members of each group are stored by the apparatus, preferably in the database 7 attached to the SCP 5. The group definitions are retrieved from the database 7 using a combination of the service number and the calling line identity (CLI) of the user, permitting each subscriber to have his own group definitions.

The operation of a preferred embodiment of the invention is now described.

There are two aspects to the technique, which are the voice and text aspects. These may be considered separately; however maximum utility is achieved when both aspects of the service are made available on the same service number, this providing a simple and memorable service model for the user. The service number may be a long number or a short code, and in any case may be stored in the user's address book in association with a memorable name, in the same way as any other personal telephone number or service number. In this way, there is no change in behavior required for the user to make use of the service, since users are usually familiar with making calls and sending text messages using the handset's built-in phone book.

Both the voice and text aspects of the technique use the same group definitions, and a preferred syntax for defining this is now described. Using the previous example of service numbers 501 to 509 being provided for accessing nine independent groups, the user may define a group of members on any of these numbers by sending a text message to the respective service number conforming to a specific format. A preferred format is for the body of the text message to commence with a defined delimiter character, and to comprise a list of telephone numbers separated by the same or a different delimiter character. A suitable character is but other delimiters or methods may be used.

In a preferred embodiment, the telephone numbers permitted in a group definition may include mobile telephone numbers on any network. Billing issues for texts or conference calls to group members on other networks are automatically taken care of by existing billing mechanisms, since the originator pays for all of these. In alternative embodiments, fixed line telephone numbers may also be included. Text messages sent to these numbers may be handled in a variety of ways, including text to voice-call translation, text to email translation and message discard.

Initiation of a text message to a group works as follows:

The originator composes a text message in the normal way, and sends the message either by entering the service number or by selecting the corresponding entry in his handset phone book. The mobile telephone network is configured to intercept text messages sent to this service number. This is typically achieved by the SMS router 6 in the mobile originated (MO) text path, before message arrival at an SMSC. The SMS router 6, in conjunction with an attached database and possibly in conjunction with an external processing server, is configured to replicate the mobile originated message and to substitute the addresses of the corresponding group members in place of the service number. The message may then be direct-delivered in mobile terminated (MT) format to these recipients, or forwarded in mobile originated format to an SMSC for store-and-forward delivery. If a delivery receipt was requested with the original message, then the delivery receipt request may be transferred to each of the replicated messages, resulting in delivery receipts being obtained for each of the delivered messages.

Initiation of a conference call with a group works as follows:

The originator makes a voice call in the normal way, either by entering the service number or by selecting the corresponding entry in his handset phone book. The network routes this call to the apparatus, where it is received by the switch 3. The switch 3 then queries the SCP 5, passing the CLI of the caller. Using stored information about current conferences and free ports on the conference units, the SCP 5 reserves resources on one of the conference units 4. Using a combination of the CLI, the service number and its database, the SCP 5 identifies the group members to be contacted. The SCP 5 then instructs the switch 3 to dial out to each of the group members in parallel, and to connect these callers into a conference with the initiator. The CLI presented to each of the outdialled parties is preferably that of the initiator.

Optionally, if any of the outdialled parties with a mobile telephone number is busy, a text message may be sent containing a unique telephone number selected by the SCP 5 from a range allocated to the apparatus. If this party later calls this number whilst the conference is still in progress then he will be connected into the same conference. A CLI security check is preferably also done to prevent uninvited entrants.

In an alternative embodiment, all of the group participants, apart from the initiator, may be joined to the conference in that way, that is by sending a pro-forma text message inviting each member to immediately join an audio conference with the initiator (identified by his CLI), the text message containing the number to dial. The CLI of the text message is preferably that of the initiator.

This method has the advantage that each member pays for his own call, but has the restriction that only mobile numbers may be invited. The initiator still benefits from the simplicity of making only a single voice call.

The key benefit of the described technique is the ability for a mobile subscriber to predefine one or more groups, and to contact them all by text or audio conference with such simplicity that there is no barrier to use, since the handset phone book is used in the same way as for a normal message or call.

In so far as the embodiment of the invention described above may be implemented, at least in part, using software-controlled processing apparatus, it will be appreciated that a computer program providing such software control and a storage medium by which such a computer program is stored are envisaged as aspects of the invention.

1-20. (canceled)

21. Telecommunications services apparatus for use with a mobile telephone network, the apparatus being operable to store for a first user addresses representing members of at least one group of users, said addresses being configurable by the first user, wherein the first user may send a text message to a service address corresponding to one of the at least one group of users, the apparatus being thereby operable to replicate the text message to the members of that group of users, and wherein the first user may make a voice call to the same service address, the apparatus being thereby operable to initiate an audio conference with the members of that group of users.

22. Apparatus according to claim 21, wherein the service address for the or each respective group of users comprises a short code.

23. Apparatus according to claim 21, wherein a respective service address determines a particular group of users for each individual first user, permitting each first user to have personal group definitions.

24. Apparatus according to claim 23, including a database storing addresses of the or each group of users, and wherein the calling line identity of the first user is detected and the particular group of users is determined on the basis of the service address and the detected calling line identity.

25. Apparatus according to claim 21, including an address configuring means responsive to receipt of an identifier in a text message to manage the addresses of a respective group of users, the text message including one or more addresses of the respective group of users.

26. Apparatus according to claim 25, wherein the address configuring means is also responsive to the presence of the same or a different identifier between addresses in the text message, to interpret the identifier as a delimiter between the addresses.

27. Apparatus according to claim 25, wherein the or each identifier is a specific key character.

28. Apparatus according to claim 21, including means for sending a text message to a selected one of the groups of users inviting each user in the group to join an audio conference, the text message including an address for joining the audio conference.

29. A telecommunications services method for a mobile telephone network, the method involving storing for a first user addresses representing members of at least one group of users, said addresses being configurable by the first user, (i) wherein the first user may send a text message to a service address corresponding to one of the at least one group of users, the text message being thereby replicated to the members of that group of users, and/or (ii) wherein the first user may make a voice call to a service address corresponding to one of the at least one group of users, an audio conference thereby being initiated with the members of that group of users.

30. A method according to claim 29, wherein the service address for the or each respective group of users comprises a short code.

31. A method according to claim 29, wherein a respective service address determines a particular group of users for each individual first user, permitting each first user to have personal group definitions.

32. A method according to claim 31, including storing addresses of the or each group of users in a database, and wherein the calling line identity of the first user is detected and the particular group of users is determined on the basis of the service address and the detected calling line identity.

33. A method according to claim 29, including an address configuring step responsive to receipt of an identifier in a text message to manage the addresses of a respective group of users, the text message including one or more addresses of the respective group of users.

34. A method according to claim 33, wherein the address configuring step is also responsive to the presence of the same or a different identifier between addresses in the text message, to interpret the identifier as a delimiter between the addresses.

35. A method according to claim 33, wherein the or each identifier is a specific key character.

36. A method according to claim 29, including sending a text message to a selected one of the groups of users inviting each user in the group to join an audio conference, the text message including an address for joining the audio conference.

37. A computer program for implementing a method according claim 29.

38. A storage medium storing a computer program according to claim 37.
